(19) United States
(12) Patent Application Publication
(10) Pub. No.: US 2010/0281395 A1
(43) Pub. Date: Nov. 4, 2010

(54) SYSTEMS AND METHODS FOR REMOTE FILE TRANSFER

(75) Inventor: Trent Apted, New South Wales (AU)

Correspondence Address: Workman Nydegger;1000 Eagle Gate Tower, 60 East South Temple, Salt Lake City, UT, 84111, US

(73) Assignee: SMART INTERNET TECHNOLOGY CRC PTY LTD, Eveleigh (AU)

(21) Appl. No.: 12/677,760

(22) PCT Filed: Sep. 11, 2008
(86) PCT No.: PCT/AU08/01343

§ 371 Date: Jun. 23, 2010

(30) Foreign Application Priority Data
Sep. 11, 2007 (AU) 2007904928

(51) Int. Cl. G06F 3/048; G06F 15/16

(52) U.S. Cl. 715/748; 715/769

(57) ABSTRACT

The present invention provides a method for transferring files between first and second computing devices. The method includes the steps of providing a first user interface associated with the first computing device; displaying a remote screen interface on the first user interface, the remote screen interface arranged to display at least one object associated with a file stored on the second computing device; and transferring the file associated with the at least one object to the first computing device, responsive to a user of the first computing device moving the object to a predetermined area of the remote screen interface.

### TECHNICAL FIELD

The present invention relates to systems and methods for transferring electronic files between two or more computing devices and more particularly, but not exclusively, to systems and methods for transferring multimedia files to/from a computer providing an interactive desktop interface.

### BACKGROUND OF THE INVENTION

It is often necessary to transfer electronic files between two or more computers. There are a wide range of transfer protocols which can be used to effect file transfer. Unlike general communications protocols, file transfer protocols are designed to send a stream of bits, typically over a network, from a source computing system to a destination or target computing system. The file is stored on the target computing system as a single unit in a file system, together with any relevant meta data (e.g. file size, file name, etc).

One such transfer protocol is the “File Transfer Protocol” or “FTP” which is commonly used for transferring files over TCP/IP networks. There are two computers involved in an FTP file transfer, namely the server computer and the client computer. In one configuration, the client computer displays a graphic user interface which allows a user of the client computer to perform a number of file manipulation operations such as uploading or downloading files to/from the server computer, edit file names, delete files, etc.

A drawback with these types of file transfer techniques is that complicated actions are typically required to initiate file transfer (i.e. upload or download). For example, users need to input lengthy code/instructions in order to locate the file and specify where the file is to be sent.

### SUMMARY OF THE INVENTION

In a first aspect, the present invention provides a method for transferring files between first and second computing devices, the method comprising the steps of: providing a first user interface associated with the first computing device; displaying a remote screen interface on the first user interface, the remote screen interface arranged to display at least one object associated with a file stored on the second computing device; and transferring the file associated with the at least one object to the first computing device, responsive to a user of the first computing device moving the object to a predetermined area of the remote screen interface.

In the context of the specification, the term “file” is intended to be construed broadly and include within its scope any block of arbitrary data that is utilizable by a computing system. Files may, for example, include multimedia files (e.g. audio files, video files, data files, etc.). Moreover, the files may be encoded or encrypted files.

In an embodiment, the predetermined area is located along at least one edge of the remote screen interface. For example, the predetermined area may be a bounding box which internally surrounds the remote screen interface. In an embodiment the bounding box comprises a one pixel-wide region along each edge of the remote screen interface. This advantageously allows a user to simply drag the desired object over the predetermined area to effect the file transfer.

In an embodiment the remote screen interface replicates at least a portion of a second user interface associated with the second computing device. The remote screen interface may be generated based on frame buffer data provided by the second computer. In an embodiment, the remote screen interface may advantageously act as an interactive interface for controlling the file transfer by the first computer.

In an embodiment, the method comprises the further step of displaying a second object associated with the transferred file on the first user interface. The second object may be the same as the first object. For example, the object may be an icon associated with the file which can be manipulated on the remote screen interface to effect the file transfer.

In an embodiment, the method comprises the further step of loading/executing the transferred file, whereby data associated with the loaded/executed file is displayed on the first user interface. In an embodiment, the method comprises the further step of displaying at least one of the object and executed/loaded file on the first user interface in close proximity to region in which the object entered the predetermined area, such that the object appears as though it is being seamlessly passed from the remote screen interface to the first user interface.

In an embodiment, the step of moving the object comprises dragging the object to the predetermined area using at least one of a user gesture, stylus and mouse. The user gesture may, for example, be a hand or finger movement carried out by the user.

In an embodiment, the first and second computers communicate using a virtual display protocol to provide the remote screen interface. For example, the virtual display protocol may include the virtual network control (VNC) protocol.

In an embodiment, the remote screen interface is an interactive frame buffer image provided by the second computing device.

In accordance with a second aspect, the present invention provides a system from transferring files between first and second computing devices, the system comprising: a first user interface associated with the first computing device and arranged to display a remote screen interface, the remote screen interface displaying at least one object associated with a file stored on the second computing device; and a transfer module arranged to transfer the file associated with at least one object to the first computing device, responsive to a user of the first computing device moving the object within a pre-determined area of the remote screen interface.

In an embodiment, the predetermined area is located along at least one edge of the remote screen interface. The predetermined area may be a bounding box which internally surrounds the remote screen interface. In an embodiment the bounding box comprises a one-pixel wide region along each edge of the remote screen interface.

In an embodiment the remote screen interface replicates at least a portion of a second user interface associated with the second computing device. The second object associated with the transferred file may be displayed on the first user interface. The second object may be the same as the first object.

The system may further comprise a processing module arranged to load/execute the transferred file, whereby data associated with the loaded/executed file is displayed on the first user interface.

In accordance with a third aspect, the present invention provides a computer program comprising at least one instruction which, when implemented on a computer readable medium of a computer system, causes the computer system to implement the method in accordance with the first aspect.

In accordance with a fourth aspect, the present invention provides a computer readable medium providing a computer program in accordance with the third aspect.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic diagram of a system for transferring files between computing devices, in accordance with an embodiment of the present invention;

FIG. 2 is a flow chart showing method steps for transferring files using the system of FIG. 1, in accordance with an embodiment of the present invention;

FIG. 3 is a screen shot of a user interface displaying a remote screen interface.

FIG. 4 illustrates an event handling process flow for updating the remote screen interface shown in FIG. 3.

FIG. 5 is a collaboration diagram of a momentum graph, in accordance with embodiments of the present invention.

FIGS. 6 to 9, are screen shots illustration example implementations of system and method embodiments.

FIG. 10 is a collaboration diagram for layout objects, in accordance with an embodiment of the present invention.

### DETAILED DESCRIPTION

In the description which follows an embodiment of the present invention is described in the context of a system and method for transferring multimedia files (such as compressed video and picture files), between two computers remotely connected over a communications network in the form of Local Area Network (LAN). However, it will be understood that the present invention is not limited to the example application described herein and is equally applicable for transferring any form of electronic file between any number and configuration of computing systems.

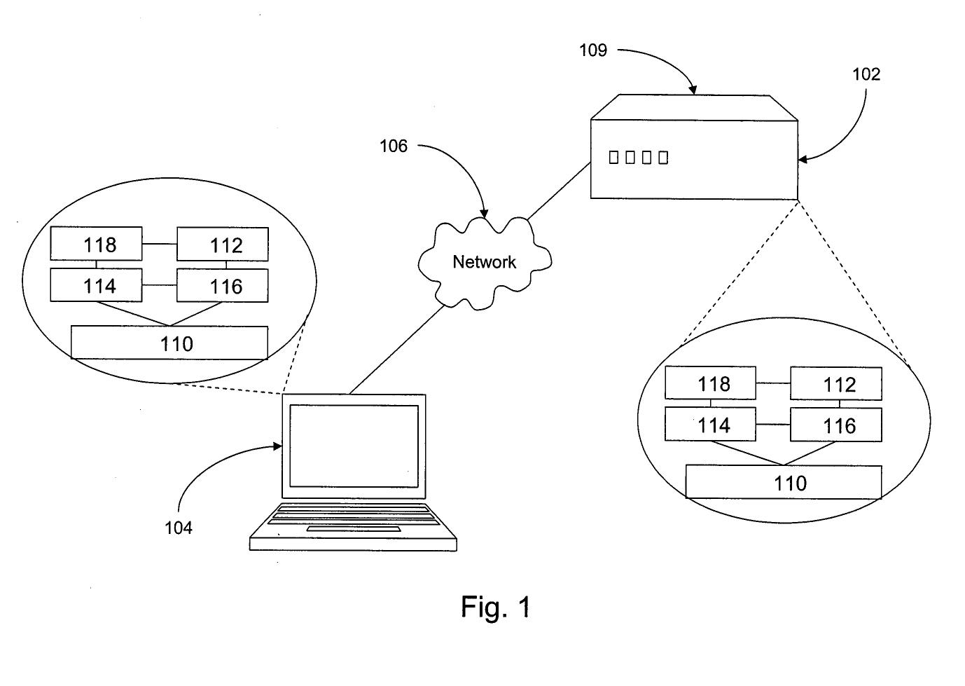

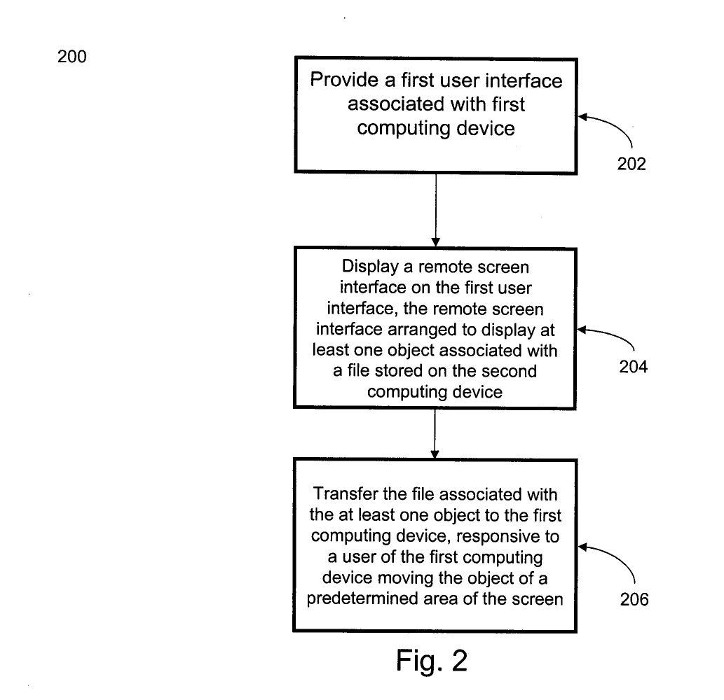

With reference to FIGS. 1 and 2, multimedia files are transferred between two computing devices in the form of a personal computer (hereafter “tabletop computer”) including a surface-mount touch screen display 109 and laptop computer 102, 104, respectively. In the embodiment described hereafter, the laptop computer 104 serves as the “host” computer, providing the multimedia files for transfer, while the tabletop computer serves as the “client” computer, configured to receive the files.

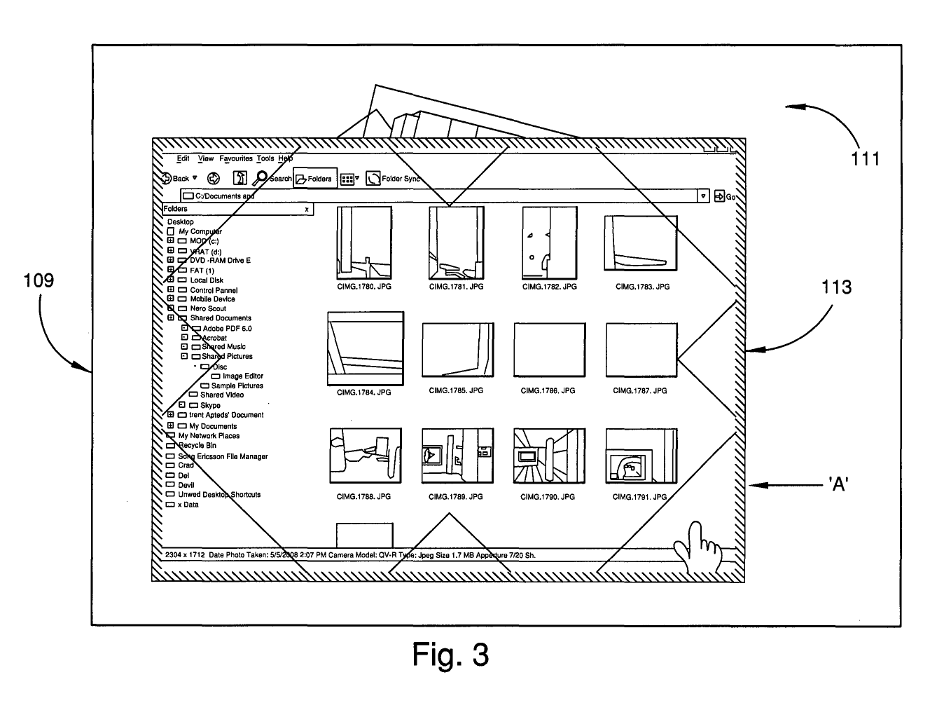

The computers 102, 104 are connected over a communications network in the form of a LAN 106 and communicate using a packet-switched protocol, such as the TCP/IP protocol. The tabletop computer 102 includes a first user interface 111 provided on the surface-mount display 109. The first user interface is a graphical user interface (GUI) arranged to display multimedia files stored by the tabletop computer 102 and receive commands for manipulating the files and objects/icons associated therewith. An interactive remote screen interface 113 (hereafter “remote screen”), in this embodiment a Microsoft Windows™ File Explorer window generated by the laptop computer 104, is additionally displayed on the first user interface 111 (step 202 of FIG. 2). The File Explorer window includes objects in the form of icons associated with multimedia files stored on the laptop computer 104. An example screen shot of the first user interface 111 displaying the remote screen 113 is shown in FIG. 3.

In order to transfer multimedia files from the laptop computer 104 to the tabletop computer 102, a user of the tabletop computer 102 drags or flicks (“flicking” is described in: Margaret R. Minsky. Manipulating simulated objects with real-world gestures using a force and position sensitive screen. SIGGRAPH Computer Graphics, 18 (3): 195-203, 1984. ISSN 0097-8930. doi: http://doi.acm.org/10.1145/964965.808598 which is incorporated herein by reference) the icons associated with files to be transferred (using a stylus, mouse, hand, etc.) to a predetermined area of the remote screen 113 (step 204). In the embodiment described herein, the predetermined area is a bounding box which internally surrounds the remote screen 113 and is indicated generally by arrow “A” in FIG. 3. Upon determining that the icon has entered the bounding box, the laptop computer 104 automatically transfers the multimedia file associated with the icon to the tabletop computer 102 over the local area network 106 (step 206).

A detailed description of the system components arranged to implement the aforementioned method is now provided.

As discussed above, the first computing device is in the form of a tabletop computer 102 providing a first user interface which functions, among other things, to receive and display multimedia files for viewing and manipulation by users of the tabletop computer 102.

To carry out this functionality, the tabletop computer 102 comprises computer hardware including a motherboard 110, central processing unit 112, random access memory 114, hard disk 116 and networking hardware 118. The tabletop computer 102 also includes a display 109 in the form of a projector which projects an image (i.e. the first user interface) onto a tabletop surface. One or more users can interact with the first user interface 111 via an input, in order to manipulate objects displayed thereon. Input to the interface 111 is provided by a touch sensitive surface of the tabletop onto which the image is projected. In addition to the hardware, the tabletop computer 102 includes an operating system (such as the Microsoft Windows™ XP operating system, which is made by Microsoft Corporation) that resides on the hard disk and which co-operates with the hardware to provide an environment in which the software applications can be executed.

In this regard, the hard disk 116 of the tabletop computer 102 is loaded with a client communications module in the form of a virtual network computing (VNC) client application operating in accordance with a virtual display protocol. The VNC client application allows the tabletop computer 102 to communicate with any number of host computers loaded with a compliant VNC server application (e.g. RealVNC, TightVNC, X11vnc, etc.). Specifically, the VNC client application is arranged to utilise frame buffer image data received from a host computer (which in the presently described embodiment is a laptop computer 104), for generating and displaying the remote screen 113. Where multiple host computers are connected, each frame buffer image appears in its own remote screen displayed on the user interface 111. The VNC client application also supports a VNC password authentication method, whereby a set password is saved in a configuration file and authenticated by a challenge-response mechanism, such as the 3DES cipher. In an embodiment, the VNC client application supports raw, copy, rectangle, rise and run-length encoding (RRE) and CoRRE update mechanisms. The tabletop computer 102 also includes a receiving module including standard software and hardware (such as a TCP/IP socket) for receiving multimedia files sent from the laptop computer 104.

The second computing device 104 (i.e. “host computer”) is in the form of laptop computer 104. The laptop computer 104 comprises essentially the same hardware as the tabletop computer 102 (i.e. a motherboard, central processing unit, random access memory, a hard disk or other similar storage device, display and user input). The laptop computer 104 also utilises a Microsoft Windows™ XP operating system. The hard disk of the laptop computer 104 is loaded with a host communication module in the form of a VNC server application. The VNC server application functions primarily to allow the laptop computer 104 to share its screen (in the described embodiment, a Microsoft Windows File Explorer window displaying objects associated with files stored by the laptop computer 104) with the tabletop computer 102, by way of the remote screen 113. A determination module in the form of a Windows application programming interface “WinAPI” program is also loaded on the laptop hard disk in order to determine when a file transfer event is required. In the embodiment described herein, the WinAPI program includes code to determine whether an object has been dragged onto an edge of the laptop's screen display. Responsive to a positive indication from the WinAPI program, a multimedia file associated with the object is communicated to the tabletop computer 102 over the LAN 106. A sample code for performing this transfer is provided in “Appendix B”.

Additional metadata is also sent together with the file to allow a second object associated with the transferred file to be displayed on the first user interface 111. In an embodiment, the second object is the same as the first object. For example, if the file is a JPEG picture file the first and second object may be an icon displaying a thumbnail of the compressed picture.

The client and host communication modules as well as the determination module operate to provide the remote screen 113 and to instruct the transfer of multimedia files once an object has entered a prescribed area “A” of the laptop display screen. In an embodiment, the process involves a first step of establishing and authenticating a connection with the laptop computer 104 utilising the VNC application loaded on the tabletop computer 102, and waiting for frame buffer updates responsive to a frame buffer update request. When a frame buffer update arrives, a hidden frame buffer stored in the system memory is updated and the bounding box of all sub-updates collected. When the frame buffer update request is complete, the single, rectangular block of pixel data that was updated is processed into a mipmapped texture by generating progressively smaller versions (by half in each width and height dimension) that allow an accurate representation of the updated region to be displayed regardless of the size of the locally displayed frame buffer ‘photograph’. As will be readily understood by persons skilled in the art, mipmaps are optimised collections of bitmap images that accompany the texture used to represent surface textures and also to increase rendering speed and reduce artifacts. Once this processing is complete, a low-priority event is added to the main queue with a reference to the texture and a mipmap update. is carried out so as to locally display the updated frame buffer region on the remote screen.

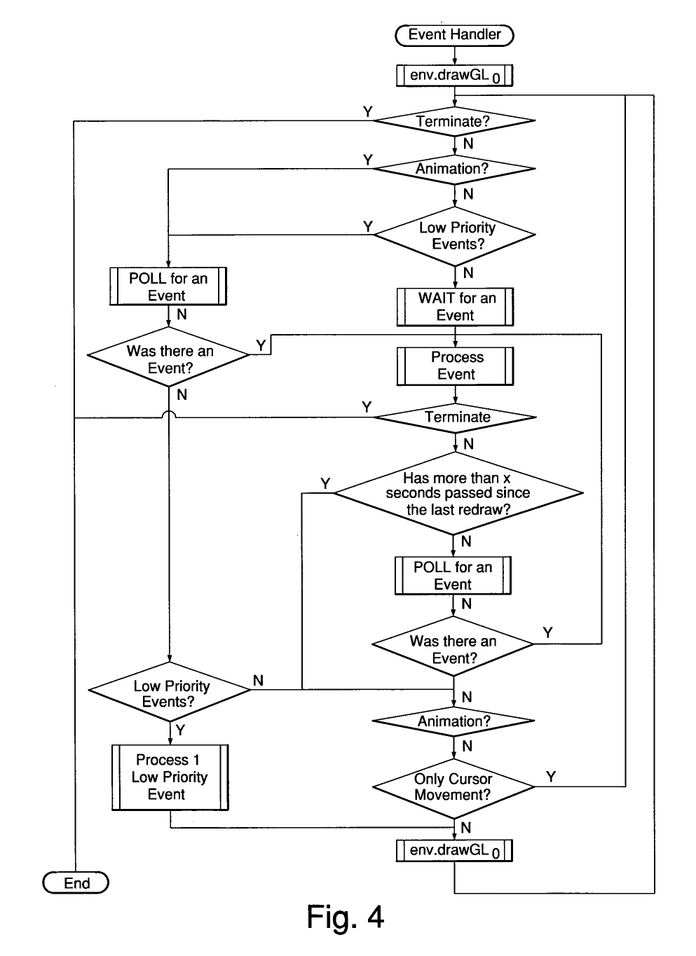

A flow chart illustrating the event handling process for the aforementioned method is shown in FIG. 4. Unlike conventional event handling processes (e.g. for 3-D games, etc.), embodiments of the event handling process of the present invention are not continuously executing. Instead, the event handling process waits for an event, before carrying out the processing steps. This provides an environment where an execution thread which handles the loading of images off the disk and converting them to mipmapped textures is given the maximum CPU time available. In contrast to conventional processes which continuously redraw to reflect dynamic environments, the event handling process shown in FIG. 4 is static while there is no interaction occurring (and at a smaller scale, between events). This advantageously allows the process to load textures in the background with minimal interruption to the interaction. Since the process creates and loads textures both when new drives are detected containing images and when a new image is captured using the frame, the system does not block any time in which textures are pre-processed and loaded into texture memory. By pre-processing textures in a concurrent thread, the system is able to load new images without any significant pauses in interaction.

In an alternative embodiment to that which has been described above, the first computing device 102 is configured as the host computing device. In this embodiment, the first computing device (hereafter “host computer”) is provided with the host communication and determination module and is arranged to transfer files to one or more second computing devices (i.e. client computers). The client computers each include display units in the form of stereoscopic “data wall” displays which are located on different walls of the room in which the host computer is located.

In further contrast to the afore-mentioned method/system, no remote screen is generated on the first user interface. Instead, the prescribed area is a bounding box which surrounds the extremity of the host computer's user interface. Responsive to the determination module determining that an object provided on the user interface has been dragged or flicked onto the bounding box, the determination module causes the file associated with the object to be transferred to the client computer having the data wall which is physically closest to the point at which the object entered the bounding box. The file and/or object associated with the transferred file may subsequently be displayed on the client computer's data wall. A sample code for determining bounds restrictions is provided in “Appendix A”, which follows this detailed description.

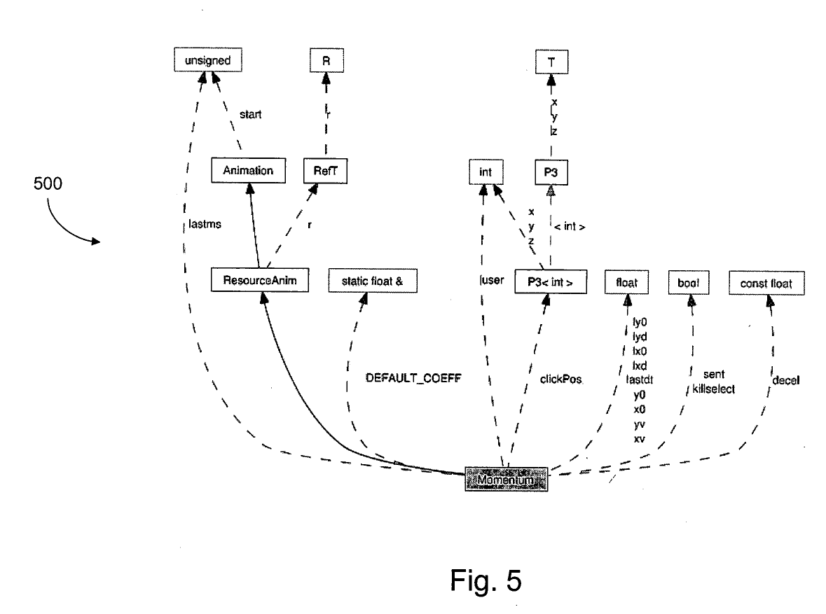

With reference to FIG. 5, the determination module will now be described in more detail. To carry out the task of determining when an object has entered a prescribed area, the determination module maintains, in a momentum graph 500, a pointer to each object, together with the position, velocity and acceleration vectors for each object. Each time the position of an object is updated, the determination module utilises the information stored in the momentum graph 500 to determine whether the object lies in the predetermined area (in the embodiment described herein, the bounding box). If it is determined that the object does lie within the bounding box, a transfer routine is called to transfer the file associated with the object. In an embodiment, an animation program provided by the determination module provides a three-dimensional animation showing the transferred file/object moving from the estimated position on the client computer display, enlarging the icon so that the icon fills the display. It is envisaged that the animation program may also support stereoscopic image files and a moving ‘carousel’ slide show.

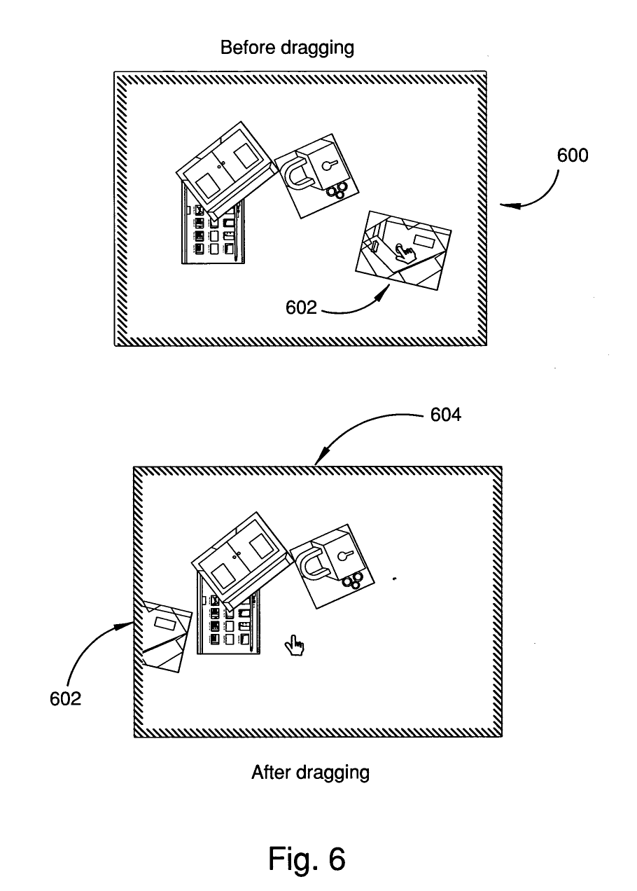

Example implementations of the above-mentioned methods/systems will now be described with reference to the screen shots of FIGS. 6 to 9.

### Example 1

### Transfer to Remote Display for Presentation (FIG. 6)

In this example embodiment a user of the tabletop computer (in this embodiment operating as the host computer) wishes to present an image currently displayed on the tabletop's user interface 600 to a large audience using a “wall mount” display (not shown). The wall mount display is provided by a projector screen associated with the client computer. In order to display the image on the projector screen, the user drags or flicks the object 602 associated with the image to the edge of the user interface 600 which is located in closest physical proximity to the wall mount display. When the object enters the bounding box 604 on that edge, the file associated with the image is sent to the client computer and loaded for display on the projector.

### Example 2

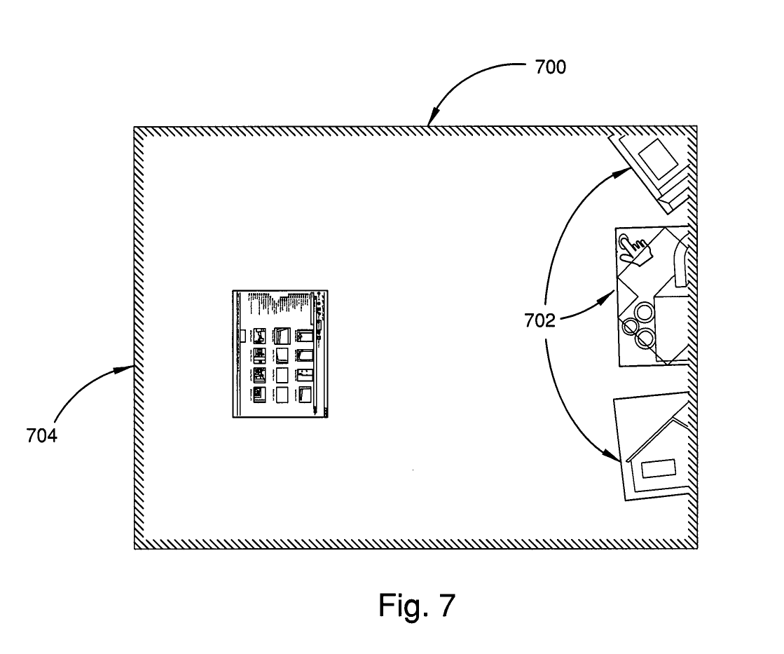

### Slide Show (FIG. 7)

A user of the tabletop computer (again operating as the host computer) wants to transfer photograph images 702 from the tabletop's user interface 700 to a client computer in the form of a digital picture frame which includes appropriate software for running a picture slide show. Images 702 to be presented in the slide show are passed to the edge of the user interface such that they enter the bounding box 704. Dragging the images 702 onto the bounding box causes the determination module to instruct the digital picture frame to include those images into the slide show. Conversely, dragging the images out of the bounding box causes the determination module to instruct the digital picture frame to remove the images 602 from the slide show.

### Example 3

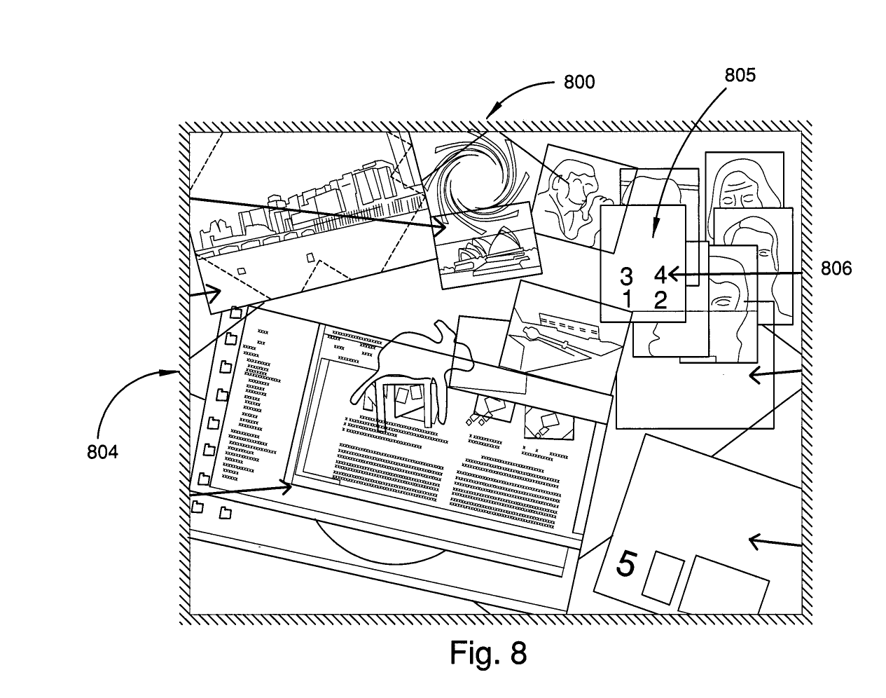

### Sending Audio Messages (FIG. 8)

In this scenario, a user of the tabletop computer sends a multimedia message (e.g. audio, video or combined audio-video) to a person associated with an object displayed on the tabletop's user interface 800. The object may, for example, be a photograph image of the person. Gesturing over the photograph image 805 (e.g. by dwelling on the image) causes a recording program loaded on the tabletop computer to begin recording using the attached microphone, accessed using the cross-platform PortAudio API (available from the Internet at URL http://www.portaudio.com). Once the desired message has been recorded by the user, gesturing again causes the message (now saved on disk as a multimedia file, such as a WAV file) to be attached to the object. At the same time, the stored multimedia file is sent to another computer responsible for managing transmission of the multimedia files (e.g. using code similar that provided in “Appendix B”, but with a header that includes an identifier for the person).

The computer transmits each image file depicting the person, followed by the saved multimedia attachment, to the tabletop computer (again, using methods similar to the sample code in “Appendix B”). On the user interface 800, a representation 806 of the audio item can be seen on the reverse side of the photograph image (displayable by flipping the image).

Conversely, the user may receive multi-media messages. In this embodiment, the user interface 800 will automatically attach the received multimedia message to the reverse side of the photograph image 805 associated with the user sending the message. The received message may be attached to the photograph image in a different colour to indicate a received message. The multimedia message may be played by gesturing or dwelling on the image 805.

To achieve this, the tabletop computer listens for messages from the client computer responsible for managing transmissions. After loading the initial “Person” images and media attachments, a TCP “server” socket is set up that receives new media items along with the identifier for the person to whom they should be attached. These then become objects that are laid out on the reverse side of the photograph image 805 and seen by flipping the image.

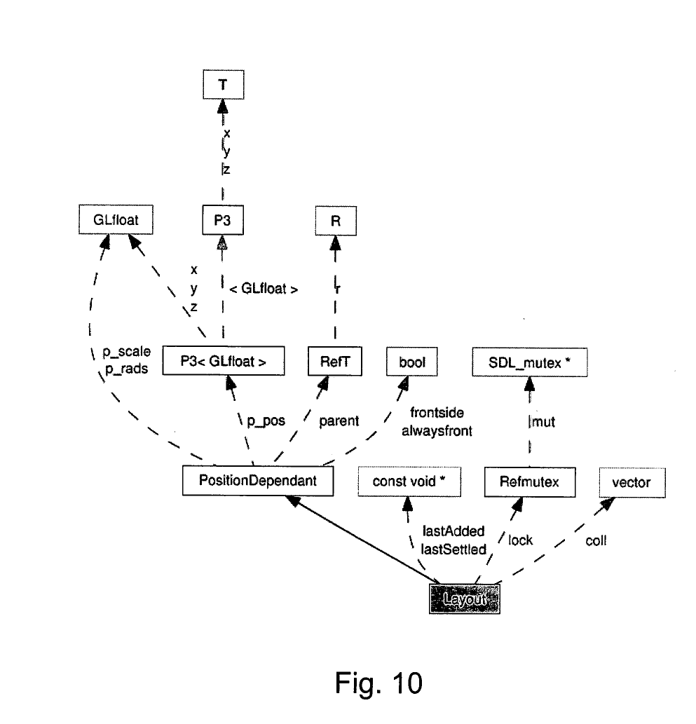

In more detail, objects located on the user interface 800, such as photograph images etc, may have a Layout associated with them (see FIG. 10). This layout includes a collection (coll) of child objects. Each time an object is moved on the interface, the communication module checks to see whether it should be attached to an object that has its reverse side visible. If it becomes attached, it is added to the collection of child objects and then sent to a second computing device. Similarly, when it becomes removed, a “remove” message is sent to the second computing device. In addition to the content of the media that was attached, an identifier for the object that it was attached to is also sent to the second computing device. Furthermore, each object may have a different second computing device to which it sends attached multimedia files.

### Example 4

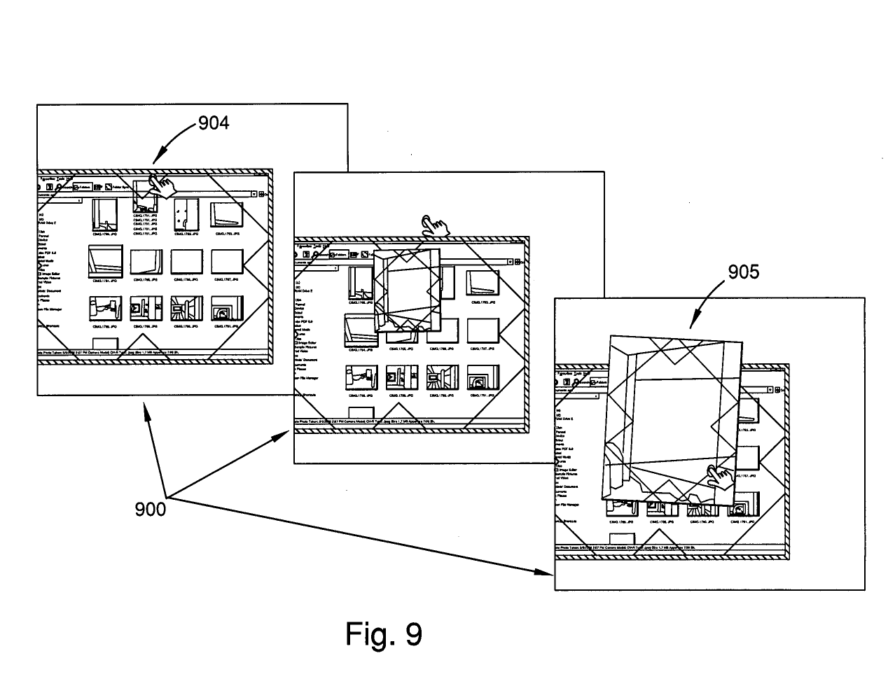

### Retrieving Media Items Off a Client Computer for Display on a Local Interface (FIG. 9)

Two people are meeting at the tabletop computer (in this embodiment, acting as the client computer) to discuss some media items in the form of photograph images 905. The images 905 are initially located on one of the person's laptop computer (i.e. host computer). The laptop computer is loaded with a VNC server application (as discussed above) and determination module. The laptop computer is instructed to display a file window, such as a File Explorer window, open at the folder containing the images for discussion. The tabletop computer is connected to the laptop using a TCP/IP connection.

On the user interface 900 of the tabletop computer, a miniature version of the laptop screen (i.e. the “remote screen interface” displaying the frame buffer image) is visible inside a photograph object which can be moved, rotated and resized like any other object displayed on the first user interface. In this embodiment, the remote screen interface 902 has two ways of becoming interactive. The first method involves using an alternate stylus, pen etc to cause the remote screen interface 902 to become interactive (i.e. not simply act as an object of the first user interface). The other method requires the image to be flipped, as discussed above. Once interactive, manipulations of the remote screen 902 that would otherwise move it etc, will now move the mouse cursor on the remote screen 902. The cursor updates are translated into the screen coordinate system of the second user interface (i.e. the laptop display), taking into account the scale, rotation and position of the frame buffer object. In addition, the cursor updates are clipped to the second user interface, if the interaction point leaves the boundary of the displayed object (which in this case is in the form of an icon).

The determination module creates four one-pixel-wide windows along each of the edges of the second user interface to form the boundary box 904. Dragging an icon from any other application on the laptop computer (e.g. from Windows File Explorer) to the edge of the screen allows the filename of that icon to be retrieved from the operating system using OLE (Object Linking and Embedding). Once an icon is dragged over one of the one-pixel borders (i.e. via the frame buffer image) the file corresponding to the icon being dragged is read from disk and sent over the communication medium (e.g. a TCP networking socket). In one embodiment, the location on the second user interface at which the image 905 was first dragged onto the boundary box is sent back to the tabletop computer and used to determine the position at which to load the image. In another embodiment, the most recently received interaction position on the tabletop user interface 900 (i.e. now on the edge, or off the frame buffer object) is used as the centre point at which to load the transferred file. Loading in this manner causes the process to appear to the user as if the icon is being converted into a viewable media item and loaded onto the table as a new object when it crosses the boundary box surrounding the frame buffer image. In order for the determination module to know where to send the media items, another step is involved. When a frame buffer object is created and successfully connects to (any) VNC server running on the laptop computer, a message is sent to the determination module. Future icon drags are sent to the most recent computer that sent this “register” message (until an attempted send fails).

Embodiments of the present invention advantageously provide that files can simply and effectively be transferred between two or more computers with minimal user instruction or particular knowledge of the two systems. Embodiments are particularly advantageous for tabletop computers (i.e. computers which include a touch screen display provided on a table-like surface), whereby files associated with objects displayed on the tabletop screen can be transferred by simply dragging or flicking the object to a predetermined area of the screen to effect the file transfer.

Although not required, the embodiments described with reference to the Figures can be implemented via an application programming interface (API) or as a series of libraries, for use by a developer, and can be included within another software application, such as a terminal or personal computer operating system or a portable computing device operating system. Generally, as program modules include routines, programs, objects, components, and data files that perform or assist in the performance of particular functions, it will be understood that the functionality of the software application may be distributed across a number of routines, objects and components to achieve the same functionality as the embodiment and the broader invention claimed herein. Such variations and modifications are within the purview of those skilled in the art.

A reference herein to a prior art document is not an admission that the document forms part of the common general knowledge in the art in Australia.

```
APPENDIX A
/**
* Position update procedure for momentum
*\return true if the Animation has finished
*/
bool Momentum::rel_update(unsigned ms)
{
    // use \f$ s = ut + \frac{1}{2}at\hat{ }2 \f$ --
    // classic physics formula for displacement
    // given initial velocity and acceleration over time
    float dt = 0.001*(ms − lastms);
    lastms = ms;
    if (r->selectedBy( ) != user) {
        // if someone else touched it, we stop
        if (r->selectedBy( ) >= 0)
          return true;
        // if we were just deselected, we still want border colour
        // and access restrictions, and a deselect when we stop
    killselect = true;
    }
    // see if we've been touched again by the same user, if so, stop
    if (r->clickPos != clickPos)
        return true;
    // DEcelleration due to friction/drag is directed against the x/y
    // components of _velocity_. Magnitude is just decel -- the
    (constant)
    // decelleration due to friction/drag
    float vtheta = xv == 0.0 ? M_PI/2.0 : atanf(fabs(yv / xv));
    float accel_x = (xv < 0 ? 1.0 : −1.0) * cosf(vtheta) * decel;
    float accel_y = (yv < 0 ? 1.0 : −1.0) * sinf(vtheta) * decel;
    // change the accelleration vector if we're near the black hole
    // by adding a component directed towards the centre of the blackhole
    // of magnitude BLACKHOLE_ACCEL
    if (r->blackholeDist( ) < 1.0) {
        /* note we use screen positions before the blackhole warping */
        float dx = r->env->blackhole->getPC( ).getScreen( ).x
                − r->getPC( ).getScreen( ).x;
        float dy = r->env->blackhole->getPC( ).getScreen( ).y
                − r->getPC( ).getScreen( ).y;
        float theta = dx == 0.0 ? M_PI/2.0 : atanf(fabs(dy / dx));
        accel_x += (dx < 0 ? −1.0 : 1.0)
            * RConfig::BLACKHOLE_ACCEL
            * cosf(theta)
            * (dx * xv < 0.0 ? 1.5 : 1.0);
        accel_y += (dy < 0 ? 1.0 : −1.0)
            * RConfig::BLACKHOLE_ACCEL
            * sinf(theta)
            * (dy * yv > 0.0 ? 1.5 : 1.0);
    }
    // update velocity and displacement from the acceleration vector
    float xvdiff = accel_x * dt;
    float yvdiff = accel_y * dt;
    float xdiff = xv * dt + 0.5 * accel_x * dt * dt;
    float ydiff = yv * dt + 0.5 * accel_y * dt * dt;
    xv = (fabs(xvdiff) >= fabs(xv) && r->blackholeDist( ) >= 1.0) ?
          0 :
          xv + xvdiff;
    yv = (fabs(yvdiff) >= fabs(yv) && r->blackholeDist( ) >= 1.0) ?
          0 :
          yv + yvdiff;
    if (!finite(xv) || !finite(yv)) {
        xv = yv = 0.0f;
    }
    // stop when less than 10 pixels / second -- why 10? => ~frame
    redraw
    // also stop when we're “trapped” by the centre of the Blackhole
    if (r->blackholeDist( ) < RConfig::BLACKHOLE_TRAPDIST ||
          (r->blackholeDist( ) >= 1.0 && fabs(xv) <= 20 && fabs(yv)
          <= 20)) {
        if (killselect)
            r->unSelect(user);
            if (r->blackholeDist( ) >= 1.0)
        r->settle( );
    return true;
    }
    // remember our desired position
    x0 = x0 + xdiff;
    y0 = y0 + ydiff;
    // then move to the closest screen/pixel location, restricting to bounds
    r->moveto(static_cast < int >(roundf(x0)),
                    static_cast < int >(roundf(y0)));
    if (r->getPC( ).getRealScreen( ).x + 3 >= r->env->getSurface( )->w
          && RConfig::DATAWALL_SEND && !sent) {
        // trigger send at right side of screen
        sent = true;
        datawall_send(r);
    } else if (r->getPC( ).getRealScreen( ).x <= 3
                && RConfig::MAGICMIRROR_SEND && !sent) {
        // trigger send at left side of screen
        sent = true;
        datawall_send(r, true);
    }
    return false;
}
/** Procedures controlling the triggering of a momentum animation */
void Mover::updatePositions( ) {
    if (positions.size( ) == RConfig::VELOCITY_WINDOW)
        positions.pop_back( );
    positions.push_front(std::make_pair(current_time,
    current_xy_position));
}
MoveTracker* Mover::release( ) {
    if (!RConfig::DO_MOMENTUM
          || positions.size( ) < RConfig::VELOCITY_WINDOW
          || r->hasLink( ))
        return ResourceGesture::release( );
    float dx = positions.front( ).second.x − positions.back( ).second.x;
    float dy = positions.front( ).second.y − positions.back( ).second.y;
    float dt = (positions.front( ).first − positions.back( ).first) / 1000.0f;
    float vel_sq = (dx * dx + dy * dy) / (dt * dt);
    if (vel_sq > RConfig::ESCAPE_VELOCITY &&
    r != r->env->blackhole) {
        r->env->addAnimation(new Momentum(r,
                                    dx / dt, dy / dt,
                                    positions.front( ).second.x,
                                    positions.front( ).second.y));
    }
    return ResourceGesture::release( );
}
```

```
APPENDIX B
struct SendfileHeader {
    char id_string[4]; /* = “FXY\0” */
    uint16_t x, y, pathsize;
    uint32_t filesize;
};
/**
* Send a file on disk to the remote computer whose
* address resides in the HOST environment variable.
*
* \param pathstr the path on disk of the file to send
* \param xpos the x-value of the cursor position that the
*  OLE drag event occurred at
* \param ypos the y-value of the cursor position
*/
bool SendFile(const char* pathstr, int xpos, int ypos) {
    if (!init)
    init = GetVars(HOST, PORT);
    std::string path = pathstr;
    unsigned which = GetSide( );
    //top or left, no change needed
    if (which == W_RIGHT)
    xpos = SCREEN_WIDTH;
    if (which == W_BOTTOM)
    ypos = SCREEN_HEIGHT;
    SendfileHeader head;
    strcpy(head.id_string, “XFY”);
    head.x = htons(xpos);
    head.y = htons(ypos);
    head.pathsize = htons(path.size( ));
    FILE *f = 0;
    unsigned long filesize = 0;
    if (!peer) {
    if (!(peer = tcpopen(HOST.c_str( ), PORT)))
        return false;
    sentpaths.clear( );
    }
    head.filesize = 0;
    if (sentpaths.find(path) == sentpaths.end( )) {
    f = fopen_size(path.c_str( ), &filesize, “rb”);
    head.filesize = htonl(filesize);
    sentpaths.insert(path); //regardless of failure..
    }
    //send header
    if (tcpsend(peer,
            reinterpret_cast<const char*>(&head),
            sizeof(head)))
    return reset( );
    //send filename
    if (tcpsend(peer, path.data( ), path.size( )))
    return reset( );
    if (f) {
    enum {BUFSZ = 4096}; //small buffer
    char buf[BUFSZ];
    size_t nread;
    size_t toread = filesize;
    //send file
    while (toread > 0
        && (nread = fread(buf, 1,
                      toread < BUFSZ
                      ? toread
                      : BUFSZ, f))) {
      if (tcpsend(peer, buf, nread))
        return reset( );
      toread −= nread;
    }
    fclose(f);
    }
    //tcpclose(peer); try to persist
    return true;
}
/**
* Handle the OLE data represented in stgmed
*/
BOOL handle_ole(STGMEDIUM &stgmed, int xpos, int ypos) {
    TCHAR file_name[_MAX_PATH + 1];
    std::vector<std::string> files;
    HDROP hdrop = (HDROP)GlobalLock(stgmed.hGlobal);
    if (hdrop) {
      UINT num_files = DragQueryFile(hdrop, (UINT)−1, NULL, 0);
      for (UINT i = 0; i < num_files; ++i) {
        ZeroMemory(file_name, _MAX_PATH + 1);
        DragQueryFile(hdrop, i, (LPTSTR)file_name,
                    _MAX_PATH + 1);
            files.push_back(file_name);
      }
      GlobalUnlock(hdrop);
    }
    ReleaseStgMedium(&stgmed);
    for (unsigned i = 0; i < files.size( ); ++i) {
        if (!SendFile(szFileName, xpos, ypos)) {
            /* handle error */
            break;
        }
    }
    return NOERROR;
}
```

1. A method for transferring files between first and second computing devices, the method comprising the steps of:
providing a first pervasive user interface associated with the first computing device;
displaying a remote screen interface on the first pervasive user interface, the remote screen interface arranged to display at least one object associated with a file stored on the second computing device;
transferring the file associated with the at least one object to the first computing device, responsive to a user of the first computing device moving the object to a predetermined area of the remote screen interface, and displaying the transferred file in a format suitable for manipulation in the first pervasive user interface.

2. A method in accordance with claim 1, wherein the predetermined area is located along at least one edge of the remote screen interface.

3. A method in accordance with claim 2, wherein the predetermined area is bounding box which internally surrounds the remote screen interface.

4. A method in accordance with claim 3, wherein the bounding box comprises a one pixel-wide region along each edge of the remote screen interface.

5. A method in accordance with claim 1, wherein the remote screen interface replicates at least a portion of a second user interface associated with the second computing device.

6. A method in accordance with claim 1, comprising the further step of displaying a second object associated with the transferred file on the first user interface.

7. A method in accordance with claim 6, wherein the second object is identical to the first object.

8. A method in accordance with claim 1, comprising the further step of loading/executing the transferred file, whereby data associated with the loaded/executed file is displayed on the first user interface.

9. A method in accordance with claim 5, comprising the further step of displaying at least one of the object and executed/loaded file on the first user interface in close proximity to region in which the object entered the predetermined area, such that the object appears as though it is being seamlessly passed from the remote screen interface to the first user interface.

10. A method in accordance with claim 1, whereby the object is an icon representing the associated file.

11. A method in accordance with claim 1, whereby the step of moving the object comprises dragging the object to the predetermined area using at least one of a user gesture, stylus and mouse.

12. A method in accordance with claim 1, whereby the first and second computers communicate using a virtual display protocol to provide the remote screen interface.

13. A method in accordance with claim 1, whereby the remote screen interface is an interactive frame buffer image provided by the second computing device.

14. A system from transferring files between first and second computing devices, the system comprising:
a first pervasive user interface associated with the first computing device and arranged to display a remote screen interface, the remote screen interface displaying at least one object associated with a file stored on the second computing device; and
a transfer module arranged to transfer the file associated with at least one object to the first computing device, responsive to a user of the first computing device moving the object within a pre-determined area of the remote screen interface,
wherein the transferred file is displayed in a format suitable for manipulation in the first pervasive user interface.

15. A system in accordance with claim 14, wherein the predetermined area is located along at least one edge of the remote screen interface.

16. A system in accordance with claim 15, wherein the predetermined area is a bounding box which internally surrounds the remote screen interface.

17. A system in accordance with claim 16, wherein the bounding box comprises a one-pixel wide region along each edge of the remote screen interface.

18. A system in accordance with claim 14, wherein the remote screen interface replicates at least a portion of a second user interface associated with the second computing device.

19. A system in accordance with claim 14, whereby a second object associated with the transferred file is displayed on the first user interface.

20. A system in accordance with claim 19, wherein the second object is identical to the first object.

21. A system in accordance with claim 14, further comprising a processing module arranged to load/execute the transferred file, whereby data associated with the loaded/executed file is displayed on the first user interface.

22. A computer program comprising at least one instruction which, when implemented on a computer readable medium of a computer system, causes the computer system to implement the method in accordance with claim 1.

23. A computer readable medium providing a computer program in accordance with claim 22.
